(19) United States
(12) Patent Application Publication
(10) Pub. No.: US 2010/0091717 A1
(43) Pub. Date: Apr. 15, 2010

(54) METHOD TO QUITE HIDDEN NODES

(75) Inventors: Jeffrey D. Bonta, Arlington Heights, IL (US); George Calcev, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/251,133

(22) Filed: Oct. 14, 2008

(51) Int. Cl. H04W 48/02

(52) U.S. Cl. 370/329

(57) ABSTRACT

A method and apparatus for quieting multiple channels on unlicensed spectrum is provided herein. During operation, a cluster head (or centralized controller such as a base station) will listen to determine if channels exist without primary system traffic. A message will then be sent out by the cluster head quieting the channels. All secondary nodes in the cluster will transmit a CTS-to-self if they do not hear any traffic by any primary system node (which may be nodes out of range of the cluster head) on the channels, otherwise they send a NAK on channels not being used by the hidden nodes. If a NAK is received by the cluster head, the process repeats until no NAK has been received. After the primary system is quieted, a poll message is sent by the cluster head to nodes instructing them to send a CTS-to-Self message so that the spectrum is quieted for the period indicated in the message.

### FIELD OF THE INVENTION

The present invention relates generally to communication systems and in particular, to a method and apparatus to quiet hidden nodes.

### BACKGROUND OF THE INVENTION

Recent developments within IEEE 802 have required calls for 100 Mbps throughput in mobile environments and 1 Gbps throughput in nomadic environments. In December 2006, the 802.16m task group was formed to address these requirements. In May 2007, the IEEE 802 Executive Committee granted an 802.11 working group request to form a new study group called 802.11VHT (very high throughput) to address this requirement.

The spectrum that will be used by 802.16m and 802.11vht has not been identified yet, but it is anticipated that these throughput rates will require 80 to 100 MHz of bandwidth. Unlicensed spectrum is one of the options for both 802.16m and 802.11vht. Finally, spectrum sharing and coexistence between 802.16 and 802.11 is also a requirement of 802.16h.

A broader problem to solve is how to enable a secondary TDMA-based system such as IEEE 802.16m or 3 GPP LTE to coexist with a primary CSMA-based system such as IEEE 802.11. The problem is complicated by the need to utilize multiple consecutive unlicensed channels to form a broadband channel on the order of 80-100 MHz of bandwidth. This would require the ability to enable a regular frame boundary to be established simultaneously over multiple instantiations of primary system deployments such that each primary system's CSMA MAC offers a TDMA-like frame period for the secondary system.

The problem is further complicated by the presence of hidden nodes that could degrade the performance of the secondary TDMA system. Hidden WLAN nodes may not hear the attempt of the secondary system to reserve time for a TDMA frame. Likewise, the secondary system may not realize that a hidden WLAN node is still using part of the spectrum. Therefore, a need exists for a method and apparatus for quieting hidden nodes (i.e., nodes out of range of a cluster head) within primary communication system.

### BRIEF DESCRIPTION OF THE DRAWINGS

FIG. 1 is a block diagram of nodes communicating over a set of shared channels.

FIG. 2 illustrates quieting of several channels.

FIG. 3 is a block diagram of a node which may act as a cluster head or as a secondary node.

FIG. 4 is a flow chart showing operation of the node of FIG. 3 when acting as a cluster head.

FIG. 5 is a flow chart showing operation of the node of FIG. 3 when acting as a secondary node.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for quieting multiple channels on unlicensed spectrum is provided herein. During operation, a cluster head (or centralized controller such as a base station) will listen to determine if channels exist without primary system traffic. A message will then be sent out by the cluster head quieting the channels. All secondary nodes in the cluster will transmit a CTS-to-self if they do not hear any traffic by any primary system node (which may be nodes out of range of the cluster head) on the channels; otherwise they send a NAK on channels not being used by the hidden nodes. If a NAK is received by the cluster head, the process repeats until no NAK has been received. After the primary system is quieted, a poll message is sent by the cluster head to nodes instructing them to send a CTS-to-Self message so that the spectrum is quieted for the period indicated in the message.

It should be noted that transmissions by the secondary system do not have to start at the beginning of a frame. The transmissions may start after the nodes have been quieted.

Because a cluster head will be able to quiet hidden nodes, the above procedure quickly quiets multiple channels in a fair manner while minimizing the reservation duration of all channels as a result of quieting the channels.

The present invention encompasses a method for a second communication system to quiet channels used by a first communication system. The method comprises the steps of monitoring channels used by the first communication system, determining a group of channels of the first communication system to quiet, and transmitting a first message to nodes in the second communication system over the group of channels. A determination is then made if a negative acknowledgment (NAK) has been received from the nodes in response to the first message (the negative acknowledgment provides an indication that a hidden node exists and is using a channel from the group of channels). If no NAK has been received then a second message is transmitted to the nodes in the second communication system, instructing the nodes to transmit a message quieting the group of channels.

The present invention additionally encompasses a method for a node in a secondary communication system to quiet channels used by a primary communication system. The method comprises the steps of receiving a first message indicating a group of channels to be quieted, and monitoring the group of channels to determine if any activity is detected on the group of channels by the primary communication system. If activity is detected then a negative acknowledgment (NAK) is transmitted indicating that at least one channel from the group of channels are being used by the primary communication system. However, if activity is not detected, a second message is transmitted quieting the group of channels, a third message is received instructing the node to transmit a message quieting the group of channels, and a final message is transmitted quieting the group of channels.

The present invention additionally encompasses an apparatus for a second communication system to quiet channels used by a first communication system. The apparatus comprises a receiver monitoring channels used by the first communication system, logic circuitry determining a group of channels of the first communication system to quiet, and a transmitter transmitting a first message to nodes in the second communication system over the group of channels. The logic circuitry additionally determines if a negative acknowledgment (NAK) has been received from the nodes in response to the first message (where the negative acknowledgment provides an indication that a hidden node exists and is using a channel from the group of channels) and if no NAK has been received then the logic circuitry instructs the transmitter to transmit a second message to the nodes in the second communication system instructing the nodes to transmit a message quieting the group of channels.

The present invention additionally encompasses a node in a secondary communication system that quiets channels used by a primary communication system. The node comprises a receiver receiving a first message indicating a group of channels to be quieted and monitoring the group of channels to determine if any activity is detected on the group of channels by the primary communication system, a transmitter transmitting a negative acknowledgment (NAK) when activity is detected, the NAK indicating that at least one channel from the group of channels are being used by the primary communication system, and where the transmitter transmits a second message quieting the group of channels when activity is not detected and transmitting a final message quieting the group of channels.

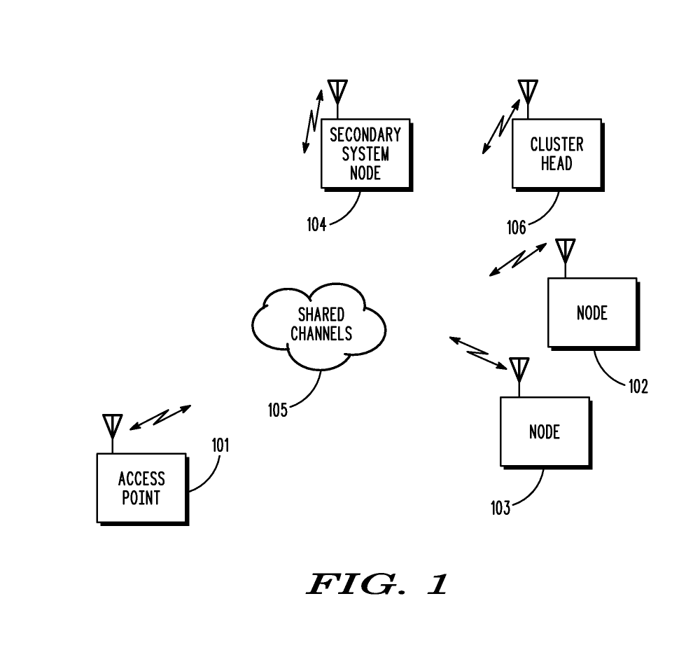

Turning now to the drawings, where like numerals designate like components, FIG. 1 is a block diagram showing nodes communicating over a plurality of shared channels. As shown in FIG. 1, a plurality of nodes 102-103 are part of a wireless local-area network (WLAN) in communication with access point 101. Access point 101 and nodes 102-103 are part of a primary communication system (e.g., 802.11a/g). Nodes 102 and 103 preferably utilize a narrowband channel (e.g., 20 Mhz) for communicating to and receiving transmissions from access point 101. Also included in FIG. 1 is node 104, which utilizes a TDMA-based system protocol (e.g. 802.16m or 3 GPP LTE). Node 104 exists as part of a secondary communication system utilizing a broadband channel comprising a plurality of narrowband channels (80-100 MHz) for transmission and reception. Shared channels 105 are provided for use by access point 101 and nodes 102-104.

In this disclosure, the secondary system is attempting to coexist with the primary WLAN system. The secondary system is assumed to have a different physical layer (PHY) than the primary WLAN system. For the sake of discussion assume that the secondary system PHY is an OFDMA PHY. The secondary system is assumed to have software defined radios (SDR) (or equivalents) that are capable of communicating with either an 802.11a/g OFDM PHY or with the OFDMA PHY and can switch dynamically between these PHYs.

The secondary system is made up of a central controller 106 and individual nodes (only node 104 shown). The central controller for the secondary system is called a cluster head (CH), but may also be referred to as a base station (BS). The CH and individual nodes of the secondary system have a wideband transceiver (e.g. 80 MHz) that can operate within any of the unlicensed spectrum bands. The secondary system will try to reserve a frame period called an RTDMA frame (reserved TDMA frame) within the unlicensed spectrum. The execution of this mechanism could be within any unlicensed band. However, the 2.4 GHz ISM band contains 12 overlapping channels that may prove difficult to manage since the beacon protocol that starts the RTDMA frame following the inventive mechanism would interfere with beacons on overlapping channels.

It is possible that cognitive algorithms could determine that no unlicensed band users are using an overlapping channel. In this case, the ISM band could be utilized. However, it is the preference is to ignore the ISM band for quieting a large broadband channel and focus on the 5 GHz unlicensed bands or some future Greenfield spectrum that does not have overlapping channels.

In order for node 104 to communicate using shared channels 105, all transmissions must cease on the channels utilized by node 104. As discussed above, the cluster head may perceive particular channels as having no transmissions, yet primary nodes that are out of range from the cluster head (hidden) may be transmitting on the channel(s). This transmission may be detected by other nodes (e.g., node 104).

In order to accomplish this, the cluster head will listen to determine channels having no primary traffic. A message will then be sent out by the cluster head quieting the channels. All secondary nodes in the cluster will transmit a message clearing the channels (e.g., a CTS-to-self) if they do not hear any traffic by any primary node (which may be nodes out of range of the cluster head); otherwise they send a non-acknowledgment message (NAK) on channels not being used by the hidden nodes. If a NAK is received by the cluster head, the process repeats until no NAK has been received. After the primary system is quieted, a poll message is sent by the cluster head to nodes instructing them to send a CTS-to-Self message so that the spectrum is quieted for the period indicated in the message. Any message transmitted contains a Network Allocation Vector (NAV) that is used to determine how long the individual channel will be occupied.

It is assumed that primary system and secondary system have equal traffic demands and thus require a 50/50 split of time to use the spectrum, the secondary system will cede control of the spectrum to primary system users after every secondary system frame. Likewise, a transition from primary system to secondary system will be instigated by the secondary system after the secondary system has deemed that an equal amount of time has been made available for the primary system users.

A certain amount of overhead is required to transition from primary system to a secondary system RTDMA frame that is a function of the longest packet transmission times of primary system. Since the maximum length 802.11 packet is roughly 2300 bytes (although technically, the maximum length MTU from a networking standpoint is only 1500 bytes) and the lowest data rate is 6 Mbps for an 802.11a/g node, the longest 802.11a/g packet transmit time is 3 msec. Therefore, to make the transition from primary system to a secondary system RTDMA frame, it may be necessary to quiet the channels for up to 3 msec. The procedure described in U.S. application Ser. No. ______ (Attorney Docket Number CML07010), which is incorporated by reference herein, will quiet all channels in an unlicensed band of a local area for the length of time required by the longest active packet (i.e. if 2 channels out of 3 have relatively short packets, but the 3rd channel has a 3 msec packet, then all three channels would be quieted for 3 msec). In an alternate embodiment, there would be advantages in monitoring the long term statistical behavior of each channel to determine the probability of maximum length packets. Using this information, the quieting procedure could take advantage of channels with shorter packets and withhold quieting them until say the last 0.5 msec or less.

In the preferred embodiment, a synchronized common reference time is established for all deployed clusters with a periodic interval that sets a window for both a secondary system RTDMA transmission opportunity and a primary system transmission opportunity. The periodic interval between the synchronized common reference times observed by all deployed clusters is 40 msec. As described previously, a secondary system frame is 2.7 msec and the maximum length 802.11a/g packet is 3 msec. Therefore, by allowing primary system users to transmit for up to 3 msec and secondary system users to transmit for 2.7 msec, there are 7 windows of transmission opportunities for primary system and secondary system users per 40 msec common reference time. This fits within the architectural requirements of a secondary system deployment which calls for groups of 7 clusters arranged to form super-clusters. Other secondary system frame structures may vary. For example, the system frame duration of IEEE 802.16m is 5 msec. With this frame structure when the primary system users are allowed to transmit for 3 msec, there are 5 transmission opportunities for primary system and secondary system users per the 40 msec. common reference time intervals. Various architectural configurations could be accommodated in this example. In one example, the secondary system (802.16m system) could use only 4 of the 5 transmission opportunities, thus leaving a full 8 msec for the primary system WLAN users on one of the transmission opportunities. Each 802.16m cell would then have four 5 msec frames in 40 msec, making it easy to schedule VoIP frames within this frame structure. In another example to improve spatial reuse of spectrum, the secondary system (802.16m) could utilize only 3 of the 5 transmission opportunities whereby each sector of a 3 sectored cell site used the same spectrum for resource allocations and operated time orthogonally to minimize interference between users of the spectrum. In yet another example, the 40 msec common reference interval could be split into 4 transmission opportunities of 10 msec. In this example, the secondary system (802.16m) could utilize three 10 msec transmission opportunities while the primary system utilized one 10 msec transmission opportunity. Obviously, many variations are possible. For the purpose of spatial reuse in a preferred embodiment, each cluster's RTDMA frame must be time orthogonal to the RTDMA frames of the other adjacent clusters.

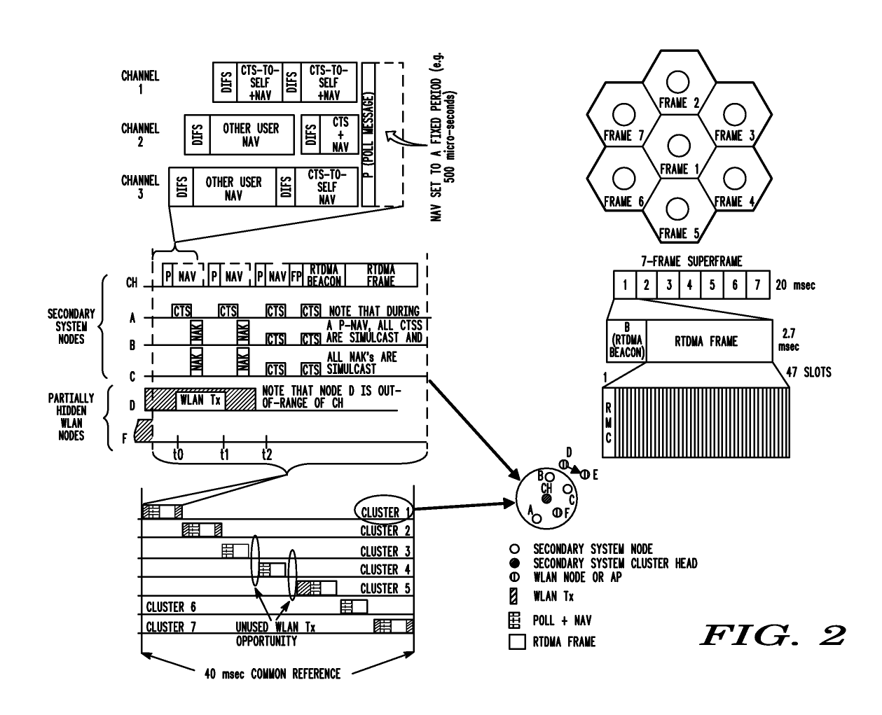

Therefore in the preferred embodiment, the start time of a secondary system RTDMA frame is designed such that no primary system or secondary system transmissions from the adjacent clusters overlap. Because the primary systems are contention based (CSMA), there is by nature uncertainty on when a new transmission can begin. As such, the system and method for reserving an RTDMA frame and insuring time orthogonality between clusters involves allowing secondary system RTDMA frames in each cluster to “float” within a 5.7 msec window. The amount of “float” is determined by the local primary system activity on the channels that need to be reserved for each cluster. The procedure for quieting unlicensed spectrum in a local area is enhanced with methodology to reserve spectrum across a wider area where the potential for hidden nodes exist. Specifically, the cluster head is responsible for insuring that all nodes within its domain are not hearing transmissions from hidden primary system nodes. This is accomplished with a protocol that gives the subordinate secondary system nodes the opportunity to approve the start of the RTDMA frame based on their local measurements of idle unlicensed spectrum. The enhanced procedure and the overall solution to transition from primary system to secondary system once per frame are best described through an example. FIG. 2 depicts the example of the proposed solution at the beginning of the 40 msec common reference interval.

In the lower right corner of FIG. 2, a topology of nodes within cluster 1 is depicted. A primary system node F is shown within the coverage area of the cluster head (CH). Triggered by the start of the 40 msec common reference interval, the CH of cluster 1 has executed the procedure to quiet the 3 primary system channels after the transmission of node F as shown in the upper left corner of FIG. 2. Two additional primary system nodes D and E are shown outside the coverage area of CH. As such, when CH senses each of the primary system channels, it is unable to measure significant energy from nodes D or E.

With a set of quiet channels (as perceived by the CH), the CH broadcasts a Poll message (P) with a Network Allocation Vector (NAV) window size set to 0.5 msec (arbitrary value). This message will keep all primary system nodes that can decode the Poll Message silenced for the duration of the NAV. However, there will be primary system nodes that are hidden from the cluster head that cannot decode the Poll Message and may continue to use the channels. These primary system nodes must be silenced by secondary system nodes that are members of the cluster. Secondary system nodes A, B, and C use their respective transceivers to observe whether valid primary system transmissions are occurring on each of the non-overlapping channels that make up the 80 MHz band that they are operating in.

As can be seen at time t0 on the timeline in the middle left of FIG. 2, node-A sends a CTS-to-self (or equivalent) before the expiration of the NAV established by the cluster head's Poll Message. The CTS-to-self sent by node-A is simulcast with all other secondary system nodes that receive the Poll Message but have not observed any valid primary system transmissions from non-secondary system nodes. This CTS-to-self is sent across all channels to reserve the channels within node-A's propagation range for a NAV duration equivalent to the NAV that the CH established with the Poll message.

Also at time t0 on the timeline in the middle left of FIG. 2, node-B and node-C have observed a valid primary system transmission from node D. This results in both node-B and node-C transmitting a NAK message to the CH before the expiration of the NAV established by the cluster head's Poll Message. The NAK can be implemented as a single symbol since no information needs to be conveyed about the source or destination of the message. The NAK sent by node-B and node-C are simulcast with all other secondary system nodes that receive the Poll Message and have observed valid primary system transmissions from non-secondary system nodes. Note that the NAK is preferably sent on a channel that is not currently in use by a primary system transmitter. If all channels are in use, then the channel with the lowest energy is selected. Alternatively, the NAK could be sent on the control channel. In this case, a priority access mechanism would need to be in place to allow the NAK to have higher priority access over other nodes contending on the control channel prior to the contention window (e.g. priority access during Point Control Function Inter-frame space—PIFS). The non-contention approach is also possible. If multiple nodes simultaneously broadcast a NAK message, the message will still be decoded by the CH as multiple copies of the same message (multi-path) as long as the relative delay between messages is less than cyclic prefix of the secondary system OFDM symbol.

It is the responsibility of the CH during the period following the Poll Message to monitor all channels for a NAK. If at least one NAK is received, then the CH will repeat the above procedure of broadcasting another Poll Message after sensing the channels to verify that they are still quiet.

Nodes A, B, and C continue to react to the reception of the Poll Message as described above. At time t1, nodes B and C are still observing valid primary system transmissions on one of the channels that would prevent the start of a secondary system RTDMA period. However at time t2, the transmission of node D has stopped and nodes B and C (along with node-A) transmit a CTS-to-self across all channels to reserve the channels within their respective propagation range for a NAV duration equivalent to the NAV that the CH established with the Poll message.

At the end of the NAV period established with the Poll Message, the CH will have observed that it did not receive a NAK from any of its member nodes. The procedure now enables the CH to start the secondary system frame within the RTDMA period with the broadcast of a secondary system RTDMA beacon (B) on the data channel. This secondary system RTDMA beacon is a fixed length beacon. The secondary system RTDMA period will then begin immediately following the beacon. The transmission of the secondary system RTDMA beacon to start the RTDMA interval is handled as described in U.S. patent application Ser. No. ______ (Attorney Docket Number CML07010).

As mentioned, it is important to recognize the potential for hidden primary system nodes. This includes primary system nodes that are outside the coverage area of the CH since transmission from these nodes will impact secondary system nodes within the CH coverage (and vice versa). An RTDMA beacon is transmitted utilizing a CTS-to-self to quiet the region surrounding the CH followed by a unique short preamble sequence. A Final Poll Message (FP) is used to signal the start of a simulcast transmission of CTS-to-self by the cluster head and all cluster head member nodes with a NAV duration that equals the RTDMA period. The CTS-to-self is transmitted by cluster member nodes at the same time that the RTDMA Beacon is transmitted by the CH to insure that the hidden/fringe primary system nodes are silenced throughout the RTDMA period. For secondary system frame transmissions within the RTDMA interval, the CH and secondary system nodes would be advised to insure that resources are allocated and utilized in a way that keeps non-primary system users from falsely believing that one or more of the channels are free.

The simulcast is insured based upon prior network synchronization derived from the control channel of secondary system (e.g. from the base station preamble in the case of IEEE 802.16). The simulcast of a CTS-to-self occurs at a predetermined number of primary system slot times (e.g. 10) after the reception of the Poll Message. The simulcast CTS-to-self is uniquely designed to contain the same information in all nodes. This results in primary system nodes that are out of the transmission range of the CH to receive multi-path copies of the same message, thus avoiding a collision that would have made the CTS-to-self un-decodable. In the same way, the simulcast of a NAK occurs at a predetermined number of primary system slot times (e.g. 70) after the reception of the Poll Message. This results in the CH receiving multi-path copies of the same message from the individual nodes that simulcast the NAK, thus avoiding a collision that would have made the NAK un-decodable.

In an alternative implementation, each CTS-to-self or NAK is transmitted following the Poll Message after a random backoff to minimize collisions with other transmissions during this period. With this approach, the transmission of the CTS-to-self and the NAK by individual member nodes within the cluster will have a high probability of colliding with each other. As a single symbol plus possible preamble symbols, the duration of the NAK would be approximately 7-21 microseconds. If the NAV associated with the Poll Message is 0.5 milliseconds, then roughly 24-71 NAK messages could be sent. Accounting for the required random backoff to minimize collisions, 12-35 NAK messages would actually get through. The CTS-to-self message is roughly 40 bytes in length. Using the minimum data rate for 802.11a/g, this message duration would consume 53 microseconds. Again assuming a Poll Message NAV of 0.5 milliseconds, then roughly 9 CTS-to-self messages could be sent, but with consideration for the required random backoff to minimize collisions, only 4 or 5 could actually get through. The duration of the Poll Message NAV could be increased to reduce opportunities for collisions, but that comes at the expense of spectral efficiency. Note that the NAK messages must all be transmitted to the CH whereas the CTS-to-self messages are transmitted to a dispersed set of primary system nodes that are potentially outside of the coverage area of the CH. Since at least only 1 NAK needs to get through to the CH, NAK collisions would seem to be less of a concern. However, CTS-to-self collisions would be more likely. The collisions are not destructive as long as the difference between CTS arrival time at the primary system receivers is small. For that reason, it may be necessary for the cluster head scheduler to select a subset of active nodes (preferably near the fringe of the cluster) to be responsible for transmitting the CTS-to-self messages.

The example in FIG. 2 assumed a 50-50 split between primary system and secondary system, implying equal load on each system. In reality, there will be times that primary system demand is less than secondary system and times when secondary system demand is less than primary system. These demands are identified through occupancy metrics such as gap times between packets, average packet length, burstiness of traffic, number of active users, etc. The metrics are collected on primary system traffic to determine the collective load of the channels. The calculated load is then used to dynamically adjust the amount of time allocated to secondary system and primary system. In the event that primary system load shrinks, secondary system can dynamically increase the number of slots in a secondary system frame contained within the RTDMA interval. Conversely in the event that secondary system load shrinks, secondary system can dynamically decrease the number of slots in a secondary system frame contained within the RTDMA interval. With the described invention, there is much flexibility to adapt the cluster to the local load and interference being experienced by each cluster. Thus, if a single primary system hot spot in one cluster demands more that 50% of the spectrum, then all clusters within the super-cluster do not have to give up capacity to meet the demands of the isolated hot spot. Rather, only the locally affected cluster needs to adjust its time sharing with the primary system. In addition, fine adjustments are possible with additions or deletion of individual timeslots where the allocations are available in every superframe.

While most primary system users can be quieted with the transmission of a data packet with a NAV that covers the duration of the secondary system RTDMA frame, once the secondary system RTDMA frame starts, there is the potential that non-primary system users can grab one of the data channels if it thinks that nothing is being transmitted. For this reason, a further enhancement calls for the scheduler to allocate uplink transmissions (node to cluster head) in a way that sub-channel allocations per timeslot are distributed amongst nodes that are located in different parts of the cluster. In other words, if 4 uplink allocations are made for 4 nodes in different quadrants of the cluster, then the possibility of a non-secondary system node being hidden from all uplink transmissions is substantially reduced. For similar reasons, it will be desirable for the scheduler to try and keep downlink allocations compact (i.e. no holes due to unused blocks) so that the unused blocks don't get sensed as being available for use by a non-primary system user or a hidden node primary system user. As an alternative, the cluster head may transmit a busy tone in the unused blocks.

The overhead to quiet the channels for a primary system to secondary system transition is applied to the primary system. During the attempts to quiet all 3 primary system non-overlapping channels, existing primary system data traffic will be allowed to continue up to a maximum packet duration of 3 milliseconds. This implies that if data traffic is present on only one of the 3 channels, then any new traffic attempts on the 2 quiet channels will be prevented. However, this can also happen in a system with only primary system users depending on the proximity of the users of the 3 channels due to adjacent channel interference. Fortunately, the 802.11 protocol will give priority to other users that may have been blocked from access once the lengthy packet transmission finishes. Nonetheless, in this invention, additional flexibility is provided that allows unused portions of the secondary system frame to be freed up for use by primary system users, potentially providing primary system users with more than their fair share of spectrum access. This was also illustrated in the lower figure of FIG. 2.

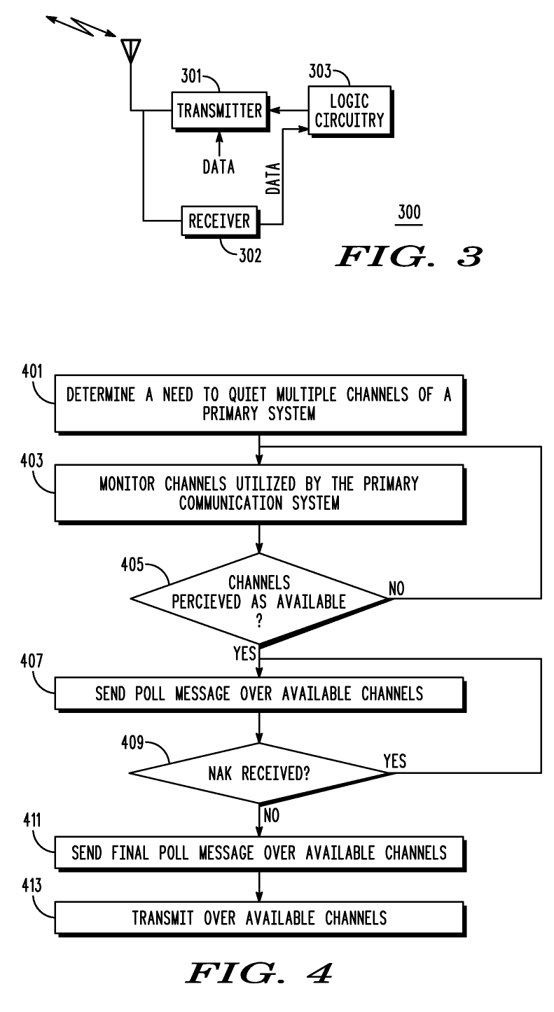

FIG. 3 is a block diagram of a node which may act as a cluster head or as a secondary node. Node 300 comprises transmitter 301, receiver 302, both coupled to logic circuitry/microprocessor 303. As discussed above, transmitter 301 comprises a wideband transmitter, while receiver 302 comprises a wideband receiver. Both transmitter 301 and receiver 302 are equipped to operate via both a primary system air interface (e.g. a CSMA system such as IEEE 802.11) or a secondary system air interface (e.g. a TDMA-based system such as IEEE 802.16, LTE, or similar communication system protocol).

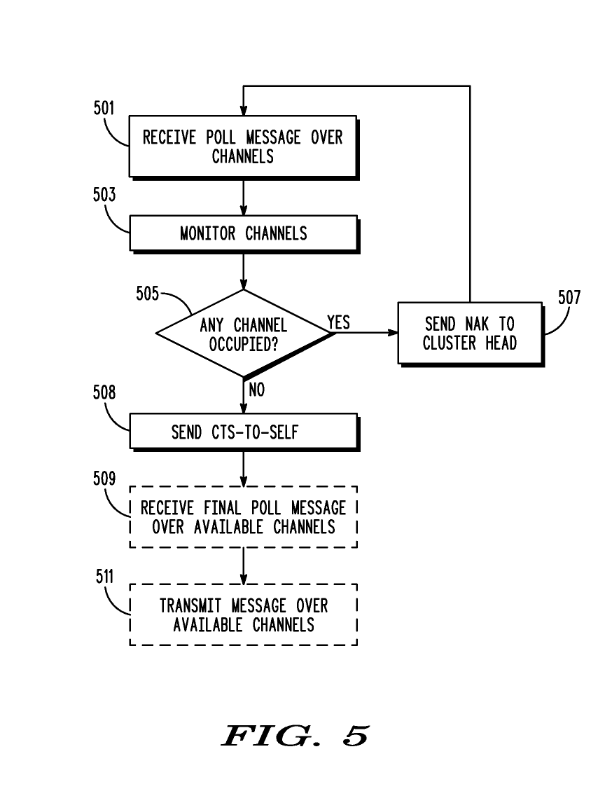

During operation of node 300, channels are quieted on the primary communication system by transmitting messages designed to quiet the channels. As discussed one or more CTS-to-self messages or training symbols may be synthesized and transmitted as either a narrowband or wideband signal to quiet the channels. Operation of node 300 takes place as described in FIG. 4 when acting as a cluster head, and in FIG. 5 when acting as a secondary node in communication with cluster head 106.

FIG. 4 is a flow chart showing operation of the node of FIG. 3 when acting as a cluster head. The logic flow particularly shows a method for a second communication system (secondary communication system) to quiet channels used by a first communication system (primary communication system). The logic flow begins at step 401 where logic circuitry 303 determines a need to quiet multiple channels of the primary communication system. Once this determination has been made, logic circuitry 303 utilizes receiver 302 to monitor the channels utilized by the primary communication (step 403). Logic circuitry 303 then determines if there exists available bandwidth (step 405) by determining if enough channels are perceived as available (i.e., perceived as having no transmissions). If, there are not enough channels perceived as available, then the logic flow returns to step 403, otherwise the logic flow continues to step 407. Once a group of channels have been determined that need to be quieted, logic circuitry 303 instructs transmitter 301 to transmit a first polling message over the group of channels. As discussed above, the first polling message will comprise a NAV, quieting the channels for an instructed period of time.

At step 409 logic circuitry 303 determines if receiver 302 received any messages (e.g., a NAK) from secondary nodes indicating that the channels are being utilized by the primary communication system. As discussed, the negative acknowledgment provides an indication that a hidden node exists and is using a channel from the group of channels.

If a NAK was received, the logic flow returns to step 407 after a period of time, and another polling message is transmitted. If, however, no NAK was received, the logic flow continues to step 411 where logic circuitry 303 instructs transmitter 301 to transmit a final polling message over the available channels. As discussed above, this final polling message will instruct all nodes in the secondary communication system to transmit a message (e.g., a CTS-to-self message containing a NAV indicating how long the channel will be occupied) quieting the group of channels for a period of time. Transmissions of information between the cluster head and secondary communication nodes then take place over the quieted channels via transmitter 301 during the RTDMA frame period.

FIG. 5 is a flow chart showing operation of the node of FIG. 3 when acting as a secondary node. The logic flow begins at step 501 where receiver 302 receives a polling message (first message) from cluster head 106, where the polling message indicates a group of channels to be quieted. In a preferred embodiment the polling message is received over the group of channels. At step 503 logic circuitry instructs receiver 302 to monitor the group of channels to see if they are occupied (i.e., if any activity is detected on the group of channels by the primary communication system). At step 505 logic circuitry 303 determines if any channels are occupied/utilized by the primary communication system. If this is the case, the logic flow continues to step 507 where a NAK is transmitted to cluster head 106, informing cluster head 106 that at least one of the channels is being utilized by the primary communication system. Preferably, the NAK is sent on a channel not being used by the primary communication system.

If, however, the channels are perceived as being unoccupied, the logic flow continues to step 508 where logic circuitry 303 instructs transmitter 301 to transmit a second message (CTS-to-self message) quieting the group of channels. For example, suppose that in FIG. 2 there was another node G that is outside of the range of the cluster head, but is within range of node A. Suppose that node G is idle. We want to make sure that node G does not start using one of the channels before the cluster head sends the final poll and starts using the wideband channel.

After step 508 the logic flow may continue to step 509 if no other nodes within the secondary communication system reported the channels as being occupied. In other words, other nodes within the secondary communication system may have reported the channels being occupied, in which case, they would have transmitted back a NAK to cluster head 106. However, if no other secondary nodes have reported a NAK back to cluster head, then receiver 302 will receive a final polling message over the available channels (step 509) instructing the node to transmit a message quieting the group of channels. In response to the third message logic circuitry 303 will instruct transmitter 301 to transmit a message quieting the channels for use (step 511). As discussed above, this message may comprise a CTS-to-self message containing a NAV.

While the invention has been particularly shown and described with reference to a particular embodiment, it will be understood by those skilled in the art that various changes in form and details may be made therein without departing from the spirit and scope of the invention. It is intended that such changes come within the scope of the following claims:

1. A method for a second communication system to quiet channels used by a first communication system, the method comprising the steps of:
monitoring channels used by the first communication system;
determining a group of channels of the first communication system to quiet;
transmitting a first message to nodes in the second communication system over the group of channels;
determining if a negative acknowledgment (NAK) has been received from the nodes in response to the first message, wherein the negative acknowledgment provides an indication that a hidden node exists and is using a channel from the group of channels; and
if no NAK has been received then transmitting a second message to the nodes in the second communication system, instructing the nodes to transmit a message quieting the group of channels.

2. The method of claim 1 wherein the second message comprises a CTS-to-self message containing a Network Allocation Vector (NAV) indicating how long the channel will be occupied.

3. The method of claim 1 wherein any NAK received is received over a channel that is not being used by the first communication system.

4. The method of claim 1 wherein the step of determining the group of channels to quiet comprises determining a group of channels perceived as having no transmissions.

5. The method of claim 1 further comprising the step of:
transmitting information over the group of channels.

6. A method for a node in a secondary communication system to quiet channels used by a primary communication system, the method comprising the steps of:
receiving a first message indicating a group of channels to be quieted;
monitoring the group of channels to determine if any activity is detected on the group of channels by the primary communication system;
If activity is detected then performing the step of transmitting a negative acknowledgment (NAK) indicating that at least one channel from the group of channels are being used by the primary communication system;
if activity is not detected, then performing the steps of:
transmitting a second message quieting the group of channels;
receiving a third message instructing the node to transmit a message quieting the group of channels; and
transmitting a final message quieting the group of channels.

7. The method of claim 6 wherein the first message is received over the group of channels to be quieted.

8. The method of claim 6 wherein the NAK is transmitted over a channel not being used by the first communication system.

9. The method of claim 6 wherein the final message comprises a CTS-to-self message containing a Network Allocation Vector (NAV) indicating how long the channel will be occupied.

10. An apparatus for a second communication system to quiet channels used by a first communication system, the apparatus comprising:
a receiver monitoring channels used by the first communication system;
logic circuitry determining a group of channels of the first communication system to quiet; and
a transmitter transmitting a first message to nodes in the second communication system over the group of channels, wherein
the logic circuitry additionally determines if a negative acknowledgment (NAK) has been received from the nodes in response to the first message, where the negative acknowledgment provides an indication that a hidden node exists and is using a channel from the group of channels, and if no NAK has been received then the logic circuitry instructs the transmitter to transmit a second message to the nodes in the second communication system instructing the nodes to transmit a message quieting the group of channels.

11. The apparatus of claim 10 wherein the second message comprises a CTS-to-self message containing a Network Allocation Vector (NAV) indicating how long the channel will be occupied.

12. The apparatus of claim 10 wherein any NAK received is received over a channel that is not being used by the first communication system.

13. The apparatus of claim 10 wherein the logic circuitry determines the group of channels to quiet by determining a group of channels perceived as having no transmissions.

14. A node in a secondary communication system that quiets channels used by a primary communication system, the node comprising:
a receiver receiving a first message indicating a group of channels to be quieted and monitoring the group of channels to determine if any activity is detected on the group of channels by the primary communication system;
a transmitter transmitting a negative acknowledgment (NAK) when activity is detected, the NAK indicating that at least one channel from the group of channels are being used by the primary communication system;
the transmitter transmitting a second message quieting the group of channels when activity is not detected and transmitting a final message quieting the group of channels.

15. The node of claim 14 wherein the first message is received over the group of channels to be quieted.

16. The node of claim 6 wherein the NAK is transmitted over a channel not being used by the first communication system.

17. The node of claim 6 wherein the final message comprises a CTS-to-self message containing a Network Allocation Vector (NAV) indicating how long the channel will be occupied.
